(19) United States
(12) Patent Application Publication
(10) Pub. No.: US 2026/0189450 A1
(43) Pub. Date: Jul. 2, 2026

(54) METHOD AND A SYSTEM FOR FACILITATING FEDERATED LEARNING IN A DECENTRALIZED NETWORK SLICING ENVIRONMENT

(71) Applicant: Samsung Electronics Co., Ltd., Suwon-si (KR)

(72) Inventors: Ganesh CHANDRASEKARAN, Bangalore (IN); Abhinay KUMAR, Bangalore (IN); Deepanshu GAUTAM, Bangalore (IN); Ashutosh KAUSHIK, Bangalore (IN); Satya Kumar VANKAYALA, Bangalore (IN); Rajesh CHALLA, Bangalore (IN)

(21) Appl. No.: 19/552,606

(22) Filed: Feb. 27, 2026

Related U.S. Application Data
(63) Continuation of application No. PCT/KR2024/012734, filed on Aug. 26, 2024.

(30) Foreign Application Priority Data
Aug. 28, 2023 (IN) 202341057699
Aug. 9, 2024 (IN) 2023 41057699

(51) Int. Cl. H04L 41/0233; H04L 9/40; H04L 41/16

(52) U.S. Cl. CPC H04L 41/0233; H04L 41/16; H04L 63/1416

(57) ABSTRACT

A method performed by a network entity for facilitating federated learning in a decentralized network slicing environment is provided. The method includes receiving, by the network entity present in each of one or more network slices associated with each of one or more network slice management function (NSMF) units, a request for creating a managed object instance (MOI) for federated learning for a network slice, from respective NSMF units, creating, by the network entity, the MOI for the federated learning for each of the one or more network slices, based on the response associated with a corresponding MOI for performance metrics, wherein an indication of the creating of the MOI for the federated learning is transmitted to the respective NSMF units, receiving, by the network entity from the respective NSMF units, a request for creating an MOI of an information object classes (IOC) for a subscription of the federated learning for respective network slices, based on the indication, wherein the MOI for subscription of the federated learning is created based on the request, and sending, by the network entity to a respective NSMF unit, a response for the federated learning based on the subscription for facilitating federated learning, when an event with respect to an associated performance metric is identified.

### CROSS-REFERENCE TO RELATED APPLICATION(S)

This application is a continuation application, claiming priority under 35 U.S.C. § 365(c), of an International application No. PCT/KR2024/012734, filed on Aug. 26, 2024, which is based on and claims the benefit of an Indian Provisional patent application number 202341057699, filed on Aug. 28, 2023, in the Indian Patent Office, and of an Indian Complete patent application number 202341057699, filed on Aug. 9, 2024, in the Indian Patent Office, the disclosure of each of which is incorporated by reference herein in its entirety.

### BACKGROUND

### 1. Field

The disclosure relates to network slicing and federated learning. More particularly, the disclosure relates to a method and a system for facilitating federated learning in a decentralized network slicing environment.

### 2. Description of Related Art

Network slicing refers to creating virtual network slices within a main network. Each of the created networks are customized for an application needs such as speed, latency, security, and the like. The network slicing allows networks such as, 5^{th} Generation (5G) network to fulfil demands for the application. Network Slice Management Function/Network Slice Subnet Management Function (NSMF/NSSMF) is characterized to orchestrate and manage the network slices of the 5G network. The NSMF manages one or more network slices based on learning of the respective network slices. Further, the learning from each of the one or more network slices is used to manage only the respective network slice. However, the learning from the one or more network slices are not aggregated. Hence, there is a need for aggregating learning from each of the network slices for facilitating a federated learning.

Conventionally, the network slices directly exchange data, leading to privacy-preserving and security issues across the network slices. Further, insufficiency of training data leads to suboptimal model performance in the network slices, especially when new network slices are added in to a decentralized network slicing environment. Hence, there is a need for providing efficient Federated Learning Framework (FLF) for handling large number of network slices and network slice management functions.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for facilitating federated learning in a decentralized network slicing environment.

Additional aspects will be set forth in part in the description which follows and, in part, will be apparent from the description, or may be learned by practice of the presented embodiments.

In accordance with an aspect of the disclosure, a method performed by a network entity for facilitating federated learning in a decentralized network slicing environment is provided. The method includes receiving, by the network entity present in each of one or more network slices associated with each of one or more network slice management function (NSMF) units, a request for creating a managed object instance (MOI) for federated learning for a network slice, from respective NSMF units, transmitting, by the network entity to a respective network slice, a request for creating an MOI for performance metrics associated with a learning model of the respective network slice based on the received request, wherein a response with respect to the MOI for performance metrics is transmitted to a respective network entity, creating, by the network entity, the MOI for the federated learning for each of the one or more network slices, based on the response associated with a corresponding MOI for performance metrics, wherein an indication of the creating of the MOI for the federated learning is transmitted to the respective NSMF units, receiving, by the network entity from the respective NSMF units, a request for creating an MOI of an information object classes (IOC) for a subscription of the federated learning for respective network slices, based on the indication, wherein the MOI for subscription of the federated learning is created based on the request, and sending, by the network entity to a respective NSMF unit, a response for the federated learning based on the subscription for facilitating federated learning, when an event with respect to an associated performance metric is identified.

In accordance with another aspect of the disclosure, a network entity for facilitating federated learning in a decentralized network slicing environment is provided. The network entity includes memory, comprising one or more storage media, storing instructions, and one or more processors communicatively coupled to the memory, wherein the instructions, when executed by the one or more processors individually or collectively, cause the network entity to receive a request for creating a managed object instance (MOI) for federated learning for a network slice, from respective network slice management function (NSMF) units, transmit, to a respective network slice, a request for creating an MOI for performance metrics associated with a learning model of the respective network slice based on the received request, wherein a response with respect to the MOI for performance metrics is transmitted to a respective network entity, create the MOI for the federated learning for each of one or more network slices, based on the response associated with a corresponding MOI for performance metrics, wherein an indication of the creating of the MOI for the federated learning is transmitted to the respective NSMF units, receive, from the respective NSMF units, a request for creating an MOI of an information object classes (IOC) for a subscription of the federated learning for respective network slices, based on the indication, wherein the MOI for subscription of the federated learning is created based on the request, and send, to a respective NSMF unit, a response for the federated learning based on the subscription for facilitating federated learning, when an event with respect to an associated performance metric is identified.

In accordance with another aspect of the disclosure, one or more non-transitory computer-readable storage media storing one or more computer programs including computer-executable instructions that, when executed by one or more processors of a network entity individually or collectively, cause the network entity to perform operations are provided. The operations include receiving, by the network entity present in each of one or more network slices associated with each of one or more network slice management function (NSMF) units, a request for creating a managed object instance (MOI) for federated learning for a network slice, from respective NSMF units, transmitting, by the network entity to a respective network slice, a request for creating an MOI for performance metrics associated with a learning model of the respective network slice based on the received request, wherein a response with respect to the MOI for performance metrics is transmitted to a respective network entity, creating, by the network entity, the MOI for the federated learning for each of the one or more network slices, based on the response associated with a corresponding MOI for performance metrics, wherein an indication of the creating of the MOI for the federated learning is transmitted to the respective NSMF units, receiving, by the network entity from the respective NSMF units, a request for creating an MOI of an information object classes (IOC) for a subscription of the federated learning for respective network slices, based on the indication, wherein the MOI for subscription of the federated learning is created based on the request, and sending, by the network entity to a respective NSMF unit, a response for the federated learning based on the subscription for facilitating federated learning, when an event with respect to an associated performance metric is identified.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment for facilitating federated learning in a decentralized network slicing environment, according to an embodiment of the disclosure;

FIG. 2 illustrates a detailed diagram of a network entity for facilitating federated learning in a decentralized network slicing environment, according to an embodiment of the disclosure;

FIG. 3 shows a sequence diagram for facilitating federated learning in a decentralized network slicing environment, according to an embodiment of the disclosure;

FIG. 4 shows illustrations for facilitating federated learning in a decentralized network slicing environment, according to an embodiment of the disclosure;

FIGS. 5A and 5B show illustrations for creation of a base learning model for facilitating federated learning in a decentralized network slicing environment, according to various embodiments of the disclosure;

FIG. 6 shows an illustration for creation of a final learning model for facilitating federated learning in a decentralized network slicing environment, according to an embodiment of the disclosure;

FIGS. 7A, 7B, and 7C show illustrations for creating a final learning model at different instances, for facilitating federated learning in a decentralized network slicing environment, according to various embodiments of the disclosure;

FIG. 8 shows a flowchart illustrating method operations for facilitating federated learning in a decentralized network slicing environment, according to an embodiment of the disclosure; and

FIG. 9 shows a block diagram of a computing system for facilitating federated learning in a decentralized network slicing environment, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or apparatus.

### Overview

Recently, container-based microservice architecture has gained substantial attention among next generation 5G/6^{th} generation (6G) telco vendors and operators. Many challenges of traditional monolithic architecture applications are tackled by microservices paradigm. However, to leverage the benefits of microservices style, one needs to use technologies aligned with characteristics of microservices for its deployment. The cloud native, container-runtime and container-orchestrator has become a popular deployment format for microservice applications among telco products.

Several commercial 5G telecommunication network products including network-elements management system (EMS), radio access central unit (CU), radio access distributed unit (DU) and 5G core (5GC) network functions are already being redesigned to fit the microservice paradigm as containers. These also align with the 5G standardization bodies such as the 3rd Generation Partnership Project (3GPP) and European Telecommunication Standards Institute (ETSI).

Telco Network Slice Management Function/Network Slice Subnet Management Function (NSMF/NSSMF) is characterized to orchestrate and manage slices of 5G Network Elements (5GNEs) in Radio Access Network (RAN), transport and core domain deployed nationwide. In cloud environments, monitoring by centralized management system (i.e., Samsung Cloud Orchestrator (SCO)) is critical for operational efficiency, closed loop automation and facilitating end-to-end (E2E) network slicing. With telco-specific products such as SCO pursuing cloud-based deployment using microservices architecture, these solutions are required to tackle multiple problems than typical monolithic based software such as disaster recovery. Telco orchestration tier provides management capabilities to a platform tier. The resource orchestration tier controls, manages, and monitors computation, storage, and network hardware, the software for the virtualization layer, and the virtualization resources. For instance, orchestration tier creates network slices, monitors network health, etc. With network slicing, telecom operators can create multiple networks for their own tenants using the same available infrastructure that meets their specific needs. Network slicing in Telco (orchestration tier) is illustrated in the disclosure. The high-level network slice management framework outlines four key management functions for network slicing including Communication Service Management Function (CSMF), the Network Slice Management Function (NSMF), the Network Slice Subnet Management Function (NSSMF) and the Network Function Management Function (NFMF). The framework further includes Network Functions Virtualization Orchestrator (NFVO), Cloud/Virtualized-Native Functions Manager (CNFM), and Cloud/Virtualized Infra Manager (CIM/VIM).

A network slice instance (NSI) may be composed of none, one, or more network slice subnet instances (NSSIs), which may be shared by another NSI. Similarly, the NSSI is formed of a set of network functions, which can be either virtual network functions (VNFs) or physical NFs (PNFs). A communication service typically uses one NSI. A network slice controller is defined as a network orchestrator, which interfaces with various functionalities performed by each layer to coherently manage each slice request, as illustrated in of the disclosure.

One such architectural aspect is the support of a service-based architecture to provide modular network services in the 5GC. TS 28.530 describes the following terms:
1. Communication Service can include a bundle of specific services, such as voice service, data service, ultra-reliable and low latency communications (URLLC) service, and so on. Each of the services are to be realized/served by different protocol data unit (PDU) sessions. Also, a specific PDU session makes use of a single network slice, and different PDU sessions may belong to different network slices.
2. Network Slice Instance (NSI) is a set of network functions (NFs) and network slice subnet instance (NSSIs) that combined together can support a certain set of communication services.
3. Network Slice Subnet Instance (NSSI) is introduced for the purpose of NSI management. NSSI is a subset of NSI and can be a combination of one or more NFs within a particular domain. NSI can consist of multiple NSSIs across different domains, like RAN and core network domains. The RAN domain can have multiple NSSIs in standalone (i.e., NSSI-a or NSSI-b). Similarly, core network domain can also have multiple NSSIs (i.e., NSSI-c, NSSI-d, etc.). NSI can be achieved by logically combining the NSSI's from different domains together, NSI-1 is achieved by combining the NSSI-a and NSSI-c. Similarly, NSI-3 is achieved by combining the NSSI's NSSI-E and NSSI-B together. Further, some of the key points to be considered include, two NSIs can be physically/logically isolated from each other either fully or partially; two or more NSIs can share a common network slice selection function (NSSF) called a shared constitute of NSI, two or more NSSIs can share a common NF called a shared constitute of NSSF, and an NSSI may contain only a core network function or only an access network function or multiple network functions within the same domain.
4. Network slice is a logical network that provides specific network capabilities and network characteristics, supporting various service properties for network slice customers. As defined in TS 23. 501 [3], network slice represents a network slice with added service properties. The network slice can be modeled using NetworkSlice Information Object Class (IOC).
5. Network Slice Instance is a Managed Object Instance (MOI) of NetworkSlice IOC. NetworkSlice instance represents service view of a network slice which exposes the root NetworkSliceSubnet instance.
6. Network Slice Subnet is a representation of a set of network functions and the associated resources (e.g., computation, storage and networking resources) supporting network slice. NetworkSliceSubnet IOC (refer to TS 28.541 [x]) is used to model network slice subnet which may include core network functions and/or RAN network functions and/or other network slice subnets. The network slice instance defined in TS 23.501 [3] can be reflected via the NetworkSliceSubnet IOC and the allocated resources.
7. NetworkSliceSubnet instance is a Managed Object Instance (MOI) of NetworkSliceSubnet IOC.
8. Service Level Specification (SLS) is a set of service level requirements associated with a Service Level Agreement (SLA) to be satisfied by a network slice.
9. Network Slice Instance Identifier (ID) is an identifier for identifying a core network Part of a NSI when multiple network slice instances of the same network slice are deployed, and there is a need to differentiate between them in the 5GC.
10. Single Network Slice Selection Assistance Information (S-NSSAI) identifies a network slice comprised of a Slice/Service Type (SST), which refers to the expected network slice behavior in terms of features and service, a Slice Differentiation (SD), which is optional information that complements the SST to differentiate amongst multiple Network Slices of the same SST.

### Narrowband (NB) OF Management and Network Orchestrator (MANO) in ETSI:

The document defines the protocol and data model for the following interfaces, in the RESTful Application Programming Interface (RESTfulAPI):
a. Network Service Descriptor (NSD) Management interface (as produced by the NFVO towards the Operations Support Systems (OSS)/Business Support Systems (BSS)).
b. Network Slice (NS) Lifecycle Management interface (as produced by the NFVO towards the OSS/BSS)
c. NS Performance Management interface (as produced by the NFVO towards the OSS/BSS)
d. NS Fault Management interface (as produced by the NFVO towards the OSS/BSS)
e. VNF Package Management interface (as produced by the NFVO towards the OSS/BSS)
f. Network Functions Virtualization Infrastructure (NFVI) Capacity Information interface (as produced by the NFVO towards the OSS/BSS)
g. VNF Snapshot Package Management interface (as produced by the NFVO towards the OSS/BSS).
h. NS Life Cycle Management (LCM) coordination interface (as produced by the OSS/BSS towards the NFVO).

### Global System for Mobile Communications Association (GSMA) E2E Service Operation and Management:

The E2E service operation and management requires interconnections with E2E network and service management domain and controllers across different technology domains to produce an E2E view of the entire network slicing. The disclosure depicts high level diagram of operation and maintenance (O&M) domain.

Currently, in the context of a FLF in NS as a service (NSaaS), there is a need for efficient training of security-related machine learning (ML) models while ensuring data privacy and security in a heterogenous NS ecosystem in various aspects:
a. Privacy Preservation: How to enable secure and privacy-preserving ML model training without directly exchanging raw data among NSs and centralizing data, while ensuring that sensitive information remains isolated within each NS.
b. Data Heterogeneity: How to handle data heterogeneity across different NS-types and achieve optimal model performance by aggregating and training ML models from diverse sources with varying data distributions.
c. Cold Start Problem: How to eliminate cold start problem, where insufficient data for training may lead to suboptimal model performance in certain NSs, especially when new slices or Communication Service Providers (CSPs) join the NS ecosystem.
d. Scalability and Efficiency: How to design a scalable and efficient FLF that can handle a large number of NSs and Communication Service Providers (CSPs) while minimizing communication overhead and latency.
e. Model Aggregation Security: How to ensure secure model aggregation in a decentralized environment, preventing adversarial nodes or malicious attacks from compromising integrity and accuracy of the aggregated ML model.

In an embodiment, the disclosure describes an approach which is related to a Federated Learning Framework (FLF) for network slicing as a service (NSaaS) in telecommunication networks. Accordingly, in an embodiment, the disclosure leverages the concept of federated learning to train security-related machine learning models locally within individual network slices, preserving data privacy and confidentiality. Further, the disclosure aggregates the model updates at a central server, enabling accurate and efficient security operations while maintaining data isolation and scalability across diverse network slices within Communication Service Providers (CSPs). Additionally, the disclosure introduces a blockchain-based sharing mechanism for secure transmission of models between CSPs, enhancing the overall NS system's ability to detect unseen attacks and foster a collaborative relationship between CSPs. As a result, the disclosure provides the following advantages:
a. Improved Privacy: The FLF approach allows data to remain decentralized and not shared directly with a central server, enhancing data privacy and confidentiality.
b. Enhanced Data Security: By avoiding the exchange of raw data, the risk of data breaches and unauthorized access is minimized, making it a more secure approach for training ML models.
c. Efficient Network Utilization: Network slicing as a service optimizes resource allocation by dividing a physical network into logical slices, enabling efficient utilization of network resources based on specific application requirements.
d. Reduced Cold Start Problem: The adoption of FLF and model aggregation between Communication Service Providers (CSPs) reduces the cold start problem, improving the performance of ML models in various network slices.
e. Scalability: The FLF allows for the aggregation of models from multiple sources, making it a scalable solution as more data sources can be added without requiring significant changes to the system.

According to one of the aspects, the disclosure discloses a framework which presents an approach tailored for NSaaS, offering enhanced privacy, security, and efficiency for training ML models while addressing specific challenges posed by distributed and heterogeneous nature of network slicing in telecommunication networks.

The proposed framework for federated learning in network slicing as a service (NSaaS) differs from existing systems in several key aspects:
a. Privacy Preservation: Unlike traditional centralized approaches, the proposed framework emphasizes privacy preservation by avoiding the direct exchange of raw data between NSs. It utilizes federated learning, where models are trained locally on individual slices, and only model updates are shared with a central server for aggregation, reducing the risk of data exposure.
b. Network Slicing as a Service (NSaaS) Integration: The disclosure specifically focuses on leveraging network slicing technology to cater to diverse application requirements in telecommunication networks. It addresses the unique challenges posed by NSaaS, such as data isolation and resource optimization, which are not extensively addressed in previous federated learning approaches.
c. Blockchain-Based Sharing: The introduction of a blockchain-based approach for securely transmitting models between Communication Service Providers (CSPs) is a novel addition. This enables the aggregation of models from multiple CSPs, enhancing the overall NS system's capabilities.

### Federated Learning Aggregation:

The disclosure discloses two-tier learning aggregation between various NSI with blockchain assistance.

Intra CSP aggregation between NSIs;

ii. Inter CSP aggregation with blockchain assistance.

The aggregation includes the following steps:

b. Select one CSP for base model generation.

c. Selected CSP adds one block with base global model.

d. Base model is sent to all other CSPs.

e. CSP sends base model to each NSI.

f. Base model training happens inside NS.

g. Learnings with weights returned to CSP.

h. CSP aggregates these learnings and create local global model using specific methods (e.g., Federated Averaging—FedAvg and FedMA).
CSP adds a block with its local global model as per smart-contract.
Adds one block with aggregated global model.
The added block is then realized by all the CSPs.

### Initial Base Model Generation:

All CSPs function as peers within the blockchain network, the process includes the following aspects.
Smart contracts govern every process on the blockchain. These are executable programs that run whenever new blocks are added.
Based on predefined logic, the smart contract designates one CSP as a leader, responsible for adding the base model. This model is validated by other CSPs.
After verification, the base model is accessible to each CSP for intra-CSP federated model aggregation.
In the diagram, the smart contract selects CSP-2 as a leader peer, adding the base model to the blockchain.

### Intra CSP Federated Models Aggregation:

The disclosure discloses the aspect of intra CSP federated models aggregation as follows:
Each CSP retrieves the global base model from the blockchain.
NSMF distributes this base model to each network slice for training.
Training takes place within each NS using local data.
Learnings from individual NSs are returned to the CSP for aggregation.

### Creating Local Global Model at CSP Level:

The disclosure discloses the aspect of creating local global model at CSP level as follows:
NSI Monitoring agent monitors 5G core services and traffic inside each slice and stores/categories the security data.
Model Manager (MM) located inside NSMF delivers the blockchain-received base model to each NSI's learning agent.
Learning agent employs data stored by monitoring agent for training the base model with ML algorithms.
Learning agent of each NSI communicates learned parameters back to MM.
MM of the CSP aggregates these learnings and employs federated algorithms, like Fed-Avg, to form a local global model at the CSP level.

### Inter Models Aggregation Between CSP Via Blockchain:

The disclosure discloses the aspect of creating local global model at CSP level as follows:
After local global models are created, each CSP adds a block containing the learnings to the blockchain.
Once all CSPs contribute their learnings to the blockchain, the smart contract designates one CSP as a leader to create the global model.
The selected CSP retains a copy of the blockchain in their local storage, accessing learnings from every CSP.
The leader CSP employs federated algorithms like Fed-Avg to formulate the global model.
The leader CSP subsequently adds a new block with the global model to the blockchain, and other CSPs verify it.
On addition to the blockchain, thereafter, the last global model may be used by all CSPs.

### Frequency of Global Model Creation:

The frequency of global model creation is determined by policy, governed by smart contracts. Using policies within the smart contract, the conditions under which a global model may be created are defined. For instance:

It can be created after a regular time interval;
When all CSP has added their learnings; and
When a quorum is achieved.

When a new block is added with learning by a CSP, a function checks if all blocks have added learnings since the last global model creation. If some CSPs are yet to add blocks, the global model creation step is skipped, and the current model persists. If all CSPs have added blocks with their learning, the global model creation function triggers a computation and addition of a new block with the global model. This new global model replaces the old one.

### Handling Malicious Clients:

Federated learning is susceptible to malicious clients (CSPs and NSs) disrupting the global model with false learnings. There are few ways to detect and remove these malicious clients such as:
Detection and removal of malicious clients are addressed through blockchain-based transaction verification.
Byzantine-Robust Federated Learning (FL) techniques detect and exclude malicious clients by identifying inconsistencies in their learnings across multiple epochs.

### Byzantine Robust FL Algorithms:

The disclosure considers existing (Differentially Private Byzantine-robust Federated Learning (DPBFL) technique. This technique uses four sub-algorithms to perform Byzantine-Robust averaging on local learnings. In DPBFL scheme, global (block chain) and CSP complies with Shuffle Protocol for Summation (SPS).

SPS contains three components:
a. Randomizer;
b. Shuffler; and
c. Analyzer.

### Sub-Algorithms:

Init->Initialize all CSP's learning models W⁰₁, W⁰₂, W⁰₃, W⁰₄, . . . , W⁰ₙ. Choose a parameter t E (0, 1) to use for Shuffle.
Loc Update->In(k+1)th iteration, each CSP may have its local learnings W^{k}.
and downloads global model W^{k}₀ and then computes:

$${x}_{i}^{k + 1} = sign ( {W}_{0}^{k} - {W}_{i}^{k} )$$

Each CSP updates its local learning model W^{k+1}ᵢ using its private dataset and current x^{k+1}ᵢ using deep learning algorithm.

$${W}_{i}^{k + 1} = {W}_{i}^{k} - {1}^{k + 1} ( ∇ L - {mx}_{i}^{k + 1} ) .$$

where sign (is elementwise sign function. ∇L is local loss gradient of CSP. m is positive constant, and l is learning rate.
Shuffle->Each CSP launches local randomizer R of shuffle protocol for summation using x^{k+1}ᵢ as input obtains noisy output y^{k+1}ᵢ and uploads it to blockchain.

$${y}_{i}^{k + 1} = R ( {x}_{i}^{k + 1} ) .$$

Aggregator->In (k+1)th iteration, master server performs summation operation on values yk+1i obtained from honest CSPs H and hk+1i obtained from unidentified malicious CSPs B. Then it computes zk+1i by using Analyzer A of SPS solution.

### Performance Evaluation and Results:

a. The disclosure implements the FLF framework using Python, PyTorch, and Scikit-learn.
b. Network Security Laboratory-Knowledge Discovery and Data Mining (NSL-KDD) intrusion detection dataset is used for the experiments as it is one of the widely used data sets among researchers.
c. Data pre-processing techniques such as, data cleaning, data transformation, and data reduction are applied to the data set before starting the training process.
d. The data set composition is balanced when the data set is considered in a high-level manner, i.e., attack and normal. However, the data set contains attack data related to several attack types.
e. Types of security attack names, its category, detection and prevention are considered.

### Dataset Description:

In one example, the dataset used contains 125972 entries of attacks, where 100000 entries are used for training and rest are used for testing accuracy of model. Dataset contains various types of attacks with varying type of protocols (internet control message protocol (icmp), transmission control protocol (tcp), and user datagram protocol (udp)). Distribution of different kind of attacks is represented by following pie charts.

### Result Comparison of Federated Learning:

By adopting the suggested federated learning framework, the disclosure accomplishes a 97.6% accuracy rate while maintaining data privacy across segments. In contrast, utilizing an isolated learning approach on a single client yielded only 82% accuracy.

### Infringement Detection (Detectability):

a. Intra and Inter model exchange/aggregation between CSP with Federated Learning framework (FLF) is a novel approach in ML that alleviates the challenges in data collection.
b. The introduction of a blockchain-based approach for securely transmitting models between CSPs. The introduction of a blockchain-based approach for securely transmitting models between CSPs.
c. As immediate step relevant sections may be taken as 3GPP SA5 study item.

### Glossary of Terms

a. CSMF: Communication Service Management Function
b. NSMF: Network Slice Management Function
c. NSI: End to End-E2E Network Slice Instance
d. NSSMF: Network Slice Subnet Management Function
e. NSSI: Network Slice Subnet Instance
f. TMF: Tele Management Forum
g. EMS: Element Management System
h. 3GPP: The 3rd Generation Partnership Project
i. ORAN: Open Radio Access Network
j. MANO: Management and Network Orchestrator
k. RAN-NSSMF: Radio Access Network-NSSMF
l. GR: Geo Redundancy
m. SCO: Samsung Cloud Orchestrator
n. CO: Cloud Orchestrator
o. EMS: Unified Service Management
p. OP: Operational Site (Active)
q. DR: Disaster Recovery Site (Standby)
r. I/F: Interface (Can be any of NBI-North or SBI-South or EBI-East or WBI-West)
s. LCM: Life Cycle Management
t. CNI: Container Native Infrastructure
u. NF: Network Function (physical-PNF/virtual-VNF/container-CNF)
v. CNFM/VNFM: CNF/VNF Manager
w. CIM/VIM: Cloud/Virtualized Infra Manager
x. FLF: Federated Learning Framework
y. AI/ML: Artificial Intelligence/Machine Learning
z. CSP: Communication Service Provider/Telco Operator

### Concepts:

Concept 1: A method for facilitating federated learning in a network slicing as a service (NSaaS) environment, comprising:
Dividing a physical network into multiple logical networks, known as network slices, to cater to diverse application requirements in future telecommunication networks (e.g., 5G/6G);
Implementing various types of network slicing, such as Enhanced Mobile Broadband (eMBB), Internet of Things (IoT), and Ultra-Reliable and Low Latency Communications (URLLC), to serve different vertical industries;
Ensuring isolation between network slices to address privacy concerns, making it challenging to collect and train centralized AI/ML models for security purposes;
NSMF during LCM of a NSI, individual monitoring and learning agent are embedded onto all managed NSs, thereby used to perform distributed monitoring and learning.

Concept 2: A novel centralized approach for training security-related ML models in a Network Slicing Ecosystem (NSE) while preserving data privacy and security operations, comprising:
Utilizing a Federated Learning Framework (FLF) to alleviate data collection challenges in the NSE;
Employing a federated server to aggregate models received from local data collection nodes using specific methods (e.g., Federated Averaging—FedAvg and FedMA);
Aggregated models are then fed back to each existing NS and also to newly created NSS i.e., reducing the cold start problem in detecting and eliminating unseen attacks;
Based on detecting a certain attack, policy enforcement can be done centrally at NS manager or inside a specific NS (depending on implementation);
Enabling ML models to be trained without exchanging data, thereby preserving data privacy and confidentiality.

Concept 3: FLF to support Dynamic Participation:

Mechanisms to enable dynamic participation of NSs in the federated learning process, allowing them to join or leave based on their availability or resource constraints.

Concept 4: A method for improving the accuracy and ability to detect unseen attacks in network slices by employing FLF with a federated server for model aggregation, comprising:
Model Personalization technique is used for personalized federated learning, where models are tailored to individual network slices' characteristics, allowing for more efficient and accurate training.
Gathering ML models local to a specific network slice or from different types of network slices or similar vertical industries (e.g., from various eMBB provided to health-care vertical industries).
Demonstrating an enhanced accuracy and elimination of the cold start problem by using FLF-based aggregation.

Concept 5: A second layer of model aggregation between Communication Service Providers (CSPs) using blockchain-based approach for securely transmitting models, comprising:
Establishing a secure sharing mechanism between CSPs, introducing a blockchain-based approach for coordination;
Integrated Byzantine fault tolerance mechanisms to ensure robustness against adversarial nodes or malicious attacks during the model aggregation process.
Implementation of version control for ML models to facilitate model versioning, rollback, and auditing, ensuring transparency and accountability in the federated learning system; and
Enhancing the overall NS system's capability to detect unseen attacks and reducing the cold start problem by aggregating models between multiple CSPs.

Concept 6: A relationship for CSPs achieved through the adoption of the blockchain-based sharing approach, comprising:
Facilitating secure transmission of models between CSPs using an adaptor; and
Enabling CSPs to enhance their NS system's performance and improve their ability to detect unseen attacks with reduced centralization load.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

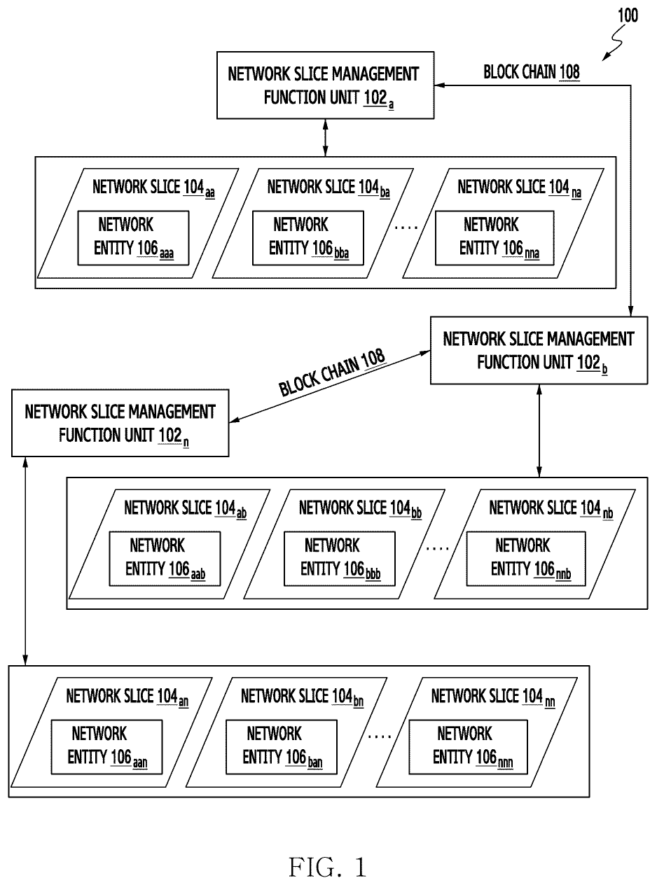

Various embodiments of the disclosure are hereinafter explained with reference to FIGS. 1 to 4, 5A, 5B, 6, 7A to 7C, 8, and 9.

FIG. 1 illustrates an environment for facilitating federated learning in a decentralized network slicing environment according to an embodiment of the disclosure.

Referring to FIG. 1, an environment 100 includes network slice management function (NSMF) units (102ₐ, 102_{b}, . . . 102ₙ), collectively referred to as one or more network slice management function (NSMF) units 102. Each of the one or more network slice management function (NSMF) units 102 comprise respective network slices (such as, 104ₐₐ, 104_{ab}, . . . 104ₐₙ, 104_{ba}, 104_{bb}, . . . 104_{bn}, 104ₙₐ, 104_{nb}, . . . 104ₙₙ, and the like, which are collectively referred to as the network slices 104). The one or more NSMF units 102 may be associated with the respective one or more network slices 104 for managing events corresponding to an application associated with each of the one or more network slices 104. The one or more NSMF units 102 may be associated with respective network slices 104 via network connections including, but not limited to, a local area network (LAN), a wide area network (WAN), a personal area network (PAN), and the like. Each of the one or more NSMF units 102 may be connected with each other in a blockchain network. Thus, the disclosure implements decentralized network slicing environment which may comprise one or more NSMF units 102 associated with the respective network slice and each of the one or more NSMF units 102 may be connected via blockchain 108.

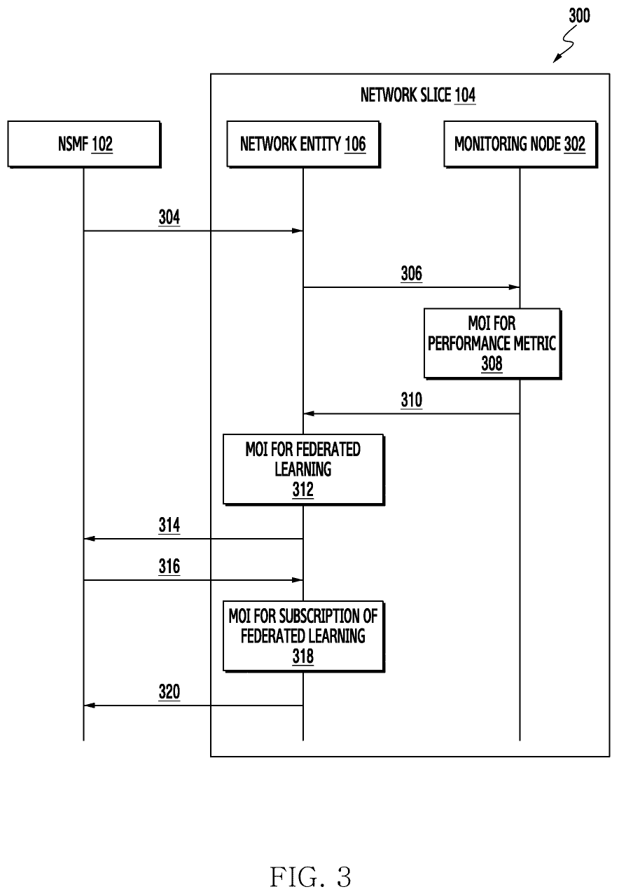

In the disclosure, each of the network slices 104 include a respective network entity and a monitoring node (not shown explicitly in FIG. 1, covered in FIG. 3). For instance, the network slice 104aa may include, a network entity 106ₐₐₐ, the network slice 104_{ba} may include, a network entity 106_{aba} and a network slice 104˜ₐ may include a network entity 106ₙₙₐ. Each of the one or more network slice 104 may comprise respective network entities (such as 106ₐₐₐ, 106_{bba}, 106ₙₙₐ . . . , 106_{aab}, 106_{bbb}, 106_{nnb}, 106ₐₐₙ, 106_{ban}, 106ₙₙₙ and the like) which are collectively referred to as network entity 106. The network entity 106 of the respective network slice 104 may be configured to facilitate federated learning in the decentralized network slicing environment by providing learning from the respective network slice to the respective NSMF unit. For instance, a network entity 106ₐₐₐ may provide the learning of a network slice 104ₐₐ to a NSMF unit 102ₐ and a network entity 106_{bba} may provide the learning of a network slice 104_{ba} to the NSMF unit 102ₐ.

In the disclosure for facilitating federated learning in the decentralized network slicing environment, the network entity 106 may receive a request for creating a Managed Object Instance (MOI) for federated learning for the network slice. The network entity 106 present in the respective network slices, may receive the request for creating the MOI, from the respective NSMF unit.

Upon receiving the request, the network entity 106 may transmit a request for creating a managed object instance (MOI) for performance metrics to the respective network slices 104. The performance metrics are associated with the respective network slices 104. Then, upon creation of the MOI for the performance metrics, the respective network slices 104 may transmit a response with respect to the MOI for performance metrics to the respective network entity 106. In an embodiment, the MOI for the performance metrics may comprise attributes such as, but not limited to, threshold, type of event, one or more objects associated with the event and classification of the event. In an embodiment, the MOI for the performance metrics may be created by identifying Key Performance Indicators (KPIs) corresponding to an application. The application may be associated with the respective network slices 104. For instance, the application may include, but not limited to telemedicine application, electric application, and the like. A threshold for each of the KPIs may be determined. An event performed on the application and the object associated with application may be determined. Then, the MOI for performance metrices corresponding to the application may be created by classifying a result of the event based on the KPIs, the threshold, the event performed on the application and the object.

Further, the network entity 106 may create the MOI for the federated learning for each of the one or more network slices 104 based on the response associated with the corresponding MOI for performance metrics. Then, an indication regarding creation of the MOI for the federated learning may be transmitted to the respective NSMF units 102. In an embodiment, the MOI for the federated learning may be created based on the creation of the MOI for performance metrices corresponding to the application using the classification of the event.

Then, upon creation of the MOI for the federated learning, the network entity 106 may receive a request for creating an MOI of an Information object Classes (IOC) for a subscription of the federated learning for the respective network slices which may be received from the respective NSMF units 102, based on the indication of the creation of the MOI for the federated learning. The MOI for subscription of the federated learning may be created based on the request. In an embodiment, the subscription of the federated learning includes subscription attributes such as, but not limited to, a subscription ID, subscriber ID, type of federated learning, frequency of updates associated with the subscription, a subscription threshold value, type of the learning model, an end time for sending response to subscription of federated learning request, subscription start time and subscription end time. The MOI for the subscription may be created based on the subscription attributes.

In an embodiment, the subscription of the federated learning may be created by evaluating validity of the subscription attributes associated with the subscription of the federated learning. The evaluation may be performed upon receiving the request for creating the subscription of the federated learning.

Upon creation of the MOI for subscription of the federated learning, a response for the federated learning based on the subscription may be sent to the respective NSMF units 102 for facilitating federated learning, when an event with respect to the associated performance metric is identified. In an embodiment, the response for the federated learning based on the subscription along with the subscription ID may be sent to the respective NSMF units 102. The response for subscription of the federated learning may be sent based on the evaluation.

Further, upon creation of the subscription for the federated learning, updates associated with the network slices may be periodically transmitted to the respective NSMF units 102 for creating a final learning model in the decentralized network slicing environment. In an embodiment, data associated with the respective network slices 104 may be received periodically for updating the learning model corresponding to the respective network slices 104. The data received may be evaluated against the subscription attributes associated with the subscription of the federated learning. The learning model may be updated based on the respective data received from the network slices 104. Then, the updated learning model associated with the respective network slices 104 may be sent to the respective NSMF units 102. The NSMF units 102 aggregate the updated learning model received from each of the one or more network slices 104 to create the final learning model.

In one example, the MOI may be created with respect to security of an application associated with the respective network slices 104. For creating MOI for security, an event may be detected as a security event for the application, by the network entity 106. An object corresponding to the security event may be identified by the respective network entity 106. The object may be associated with the application. The security event may be classified as an attack by the network entity 106, based on predefined categories of attacks and the object corresponding to the security event, by comparing a value associated with the security event with a predefined threshold associated with the security event. Then, learnings corresponding to the classification of the security event may be transmitted by the network entity 106 to the respective NSMF units 102.

In another example, the MOI may be created with respect to power usage of an application associated with the respective network slice 104. An event may be detected as a power event for the application, by the network entity 106. An object corresponding to the power event may be identified by the network entity 106. The object is associated with the application. The power event may be classified as a training cycle by the network entity 106, based on predefined categories of training cycle and the object corresponding to the power event, by comparing a value the power event with a predefined threshold associated with the power event. Then, learnings corresponding to the classification of the power event may be transmitted by the network entity 106 to the respective NSMF units 102.

Thus, the disclosure facilitates the federated learning in the decentralized network slicing environment by creating the MOI for the federated learning associated with the respective network slices 104 and creating the subscription for the MOI for the federated learning. The federated learning may help in managing the one or more network slices 104 present in the decentralized environment. This leads to improved and efficient management of the network slices 104. Further, as the disclosure facilities aggregated learning from each of the one or more network slices to the NSMF units, handling data heterogeneity across different network slices associated with different NSMF units is achieved. The disclosure may eliminate problems in facilitating learning from a new network slice added with the decentralized network environment due to insufficient data, as the disclosure aggregates learning from diverse sources with varying data distributions associated with each of the one or more network slices to create the final learning model. Further, the final learning model may be implemented in the new network slice for monitoring events associated with the new network slice. Thus, the disclosure ensures secure learning model aggregation in decentralized network slicing environment for preventing adversarial nodes or malicious events from compromising integrity and accuracy of the aggregated learning models.

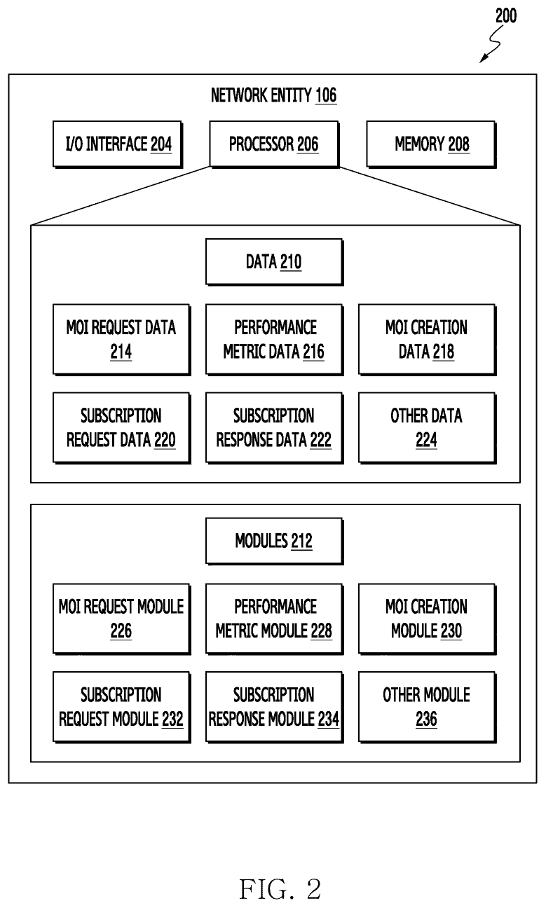

FIG. 2 illustrates a detailed diagram of a network entity for facilitating federated learning in a decentralized network slicing environment, according to an embodiment of the disclosure.

Referring to FIG. 2, diagram 200 illustrates that the network entity may include an input/output (I/O) interface 204, a processor (also referred as “Central Processing Units” and “CPUs”) 206, and memory 208. In an example embodiment, the I/O interface 204 and the memory 208 may be communicatively coupled to the processor 206. The processor 206 may include at least one data processor for executing program components for executing user or system-generated requests. The memory 208 may be communicatively coupled to the processor 206. The memory 208 stores instructions, executable by the processor 206, which, on execution, may cause the processor 206 to facilitate federated learning in the decentralized environment. In an example embodiment, the processor 206 may include one or more modules 212 and data 210. According to an example, embodiment, one or more modules 212 may be configured to facilitate federated learning in the decentralized environment. For example, the one or more modules 212 may be configured to use the data 210 and facilitate federated learning in the decentralized environment. In an example embodiment, each of the one or more modules 212 may be a hardware which may be outside the processor 206 and coupled with the network entity 106. As used herein, the term modules 212 may include, but is not limited to, an Application Specific Integrated Circuit (ASIC), an electronic circuit, a Field-Programmable Gate Arrays (FPGAs), Programmable System-on-Chip (PSoC), a combinational logic circuit, and/or other suitable components that provide described functionality.

According to an example embodiment, one or more of the modules 212 may be implemented by software or a combination of hardware and software. According to an example embodiment, the one or more modules 212 when configured with the described functionality defined in the disclosure will result in a novel hardware or may be considered as a special purpose processor. However, the disclosure is not limited thereto, and as such, the disclosure may be implemented in another way according to various other example embodiments. Further, the I/O interface 204 is coupled with the processor 206 through which an input signal or/and an output signal is communicated. For example, the network entity 106 may receive the request from the respective NSMF unit 202 via the I/O interface 204. The I/O interface 204 may include an internal interface or an external interface.

According to an example embodiment, the one or more modules 212 may include, for example, an MOI request module 226, a performance metric module 228, an MOI creation module 230, a subscription request module 232, a subscription response module 234 and other modules 236. It will be appreciated that such aforementioned one or more modules 212 may be represented as a single module or a combination of different modules. In one implementation, the data 210 may include, for example, MOI request data 214, performance metric data 216, MOI creation data 218, subscription request data 220, subscription response data 222 and other data 224.

In an example embodiment, the MOI request module 226 may be configured to receive the request for creating the MOI for federated learning for the network slices 104. The MOI request module 226 may receive the request from the respective NSMF units 102. The MOI request module 226 may be present in the network entity 106 of the network slices 104. The request received from the NSMF units 102 may be stored as the MOI request data 214 in the network entity 106. The request received may be associated with federated learning corresponding to the respective network slices 104.

FIG. 3 shows sequence diagram for facilitating federated learning in a decentralized network slicing environment, according to an embodiment of the disclosure.

Referring to FIG. 3, sequence diagram 300 illustrates that a network slice 104 may comprise a network entity 106. The network entity 106 may communicate with a monitoring node 302. In an embodiment, the network entity 106 may receive a request 304 for creating an MOI for federated learning for the network slice 104, from an NSMF unit 102.

Referring to FIG. 2, upon receiving the request for creating the MOI for the federated learning for the network slices 104, the performance metric module 228 may be configured to transmit the request for creating the MOI for performance metrics associated with the learning model of the respective network slice. In an embodiment, the performance metrics may include attributes, but not limited to the threshold, the type of event, the one or more objects associated with the event, the classification of the event. The performance metric created by the performance metric module 228 may be stored as the performance metric data 216 in the network entity 106.

In an embodiment, for creating the MOI for performance metrics, the KPIs corresponding to the application associated with the network slices 104 may be identified by the performance metric module 228. For instance, each of the one or more network slices 104 may be associated with the application. The threshold may be determined for each of the KPIs. The threshold may refer to a numerical value that may set a boundary for the performance metric. Then, the specific event performed on the object may be measured. The type of event may refer to a specific event that may be performed on the object. The one or more objects associated with the event refers to the object on which the event may be performed. The type of event and the objects associated with the application may be determined upon determining the threshold for each of the KPIs. The event may be classified based on the KPIs, the threshold, and the event performed on the object associated with the application. The classification of the events refers to assigning a predefined category or a predefined type to the event based on the performance metrics. Thus, the MOI for the performance metrics corresponding to the application may be created based on the classification of the event.

Referring to FIG. 3, network entity 106 transmits a request 306 for creating an MOI for performance metrics associated with the learning model of the respective network slice 104. The network entity 106 transmits the request 306 to the monitoring node 302, upon receiving the request 304 for creating the MOI for the federated learning from the NSMF units 102. The monitoring node 302 creates the MOI for the performance metric at operation 308. Then, the monitoring node 302 sends a response 310 with respect to creation of the MOI for the performance metric to the network entity 106.

Referring to FIG. 2, upon receiving the response with respect to creation of MOI for performance metrics, the MOI creation module 230 may be configured to create the MOI for the federated learning for each of the one or more network slices 104. Then, the indication regarding the creation of the MOI for the federated learning may be transmitted to the respective NSMF units 102 associated with the network slices 104. In an embodiment, the MOI for the federated learning may be created using the performance metrics. The MOI created for the federated learning by the network entity 106 may be stored as the MOI creation data 218 in the network entity 106.

Referring to FIG. 3, upon the network entity 106 receiving the response 310 with respect to the creation of MOI for the performance metric at operation 308, the network entity 106 may create an MOI for the federated learning at operation 312. Then, the network entity 106 may send an indication, in operation 314, to the NSMF unit 102 regarding creation of the MOI for the federated learning.

Referring to FIG. 2, upon sending the response indicating the creation of the MOI for the federated learning, the subscription request module 232 may receive the request for creating the MOI for the IOC for the subscription of the federated learning for the respective network slices 104. The subscription request module 232 may create the MOI for the subscription of the federated learning for the respective network slices 104 based on the request received for the creation of the subscription of the federated learning. The subscription of the federated learning may include subscription attributes, but not limited to, the subscription ID, the subscriber ID, the type of federated learning, the frequency of updates associated with the subscription, the subscription threshold value, the type of the learning model, the end time for sending response to subscription of federated learning request, the subscription start time and the subscription end time.

In an embodiment, the subscription ID may refer to a unique identifier for the subscription. The subscription ID may be a string type and may be used for uniquely identifying the request associated with the subscription of the federated learning. The subscriber ID may refer to an identifier of a subscribing entity. The subscriber ID may be a string type and may be used for identifying an entity that is subscribing to the application associated with the network slices. The type of federated learning may refer to specific learnings comprising attributes, associated with the learning model present in the respective network slices. The type of federated learning may be of any natural language format or key-value pairs. The type of federated learning may include additional details relevant to the subscription of the federated learning. The additional details may include, but not limited to, model parameters, the performance metrics details, and the like. The frequency of updates associated with the subscription may refer to a frequency at which updates may be received from the learning model present in the respective network slices. The frequency of updates associated with the subscription may be of string type. For instance, the frequency of updates associated with the subscription may be received hourly, daily or on an occurrence of the event. The frequency of updates associated with the subscription may define how often a subscriber receives updates with respect to the subscription to the federated learning.

The subscription threshold value may refer to a value criterion for triggering notifications. The subscription threshold may be of numerical type or Boolean expression. The subscription threshold may define conditions under which a subscription for the federated learning is created and response indicating the creation of the MOI for the subscription of the federated learning is sent to the NSMF units 102. For instance, in accuracy use case, if the subscription threshold is greater than 90%, then the indication regarding accuracy event is sent to the respective NSMF unit. The type of learning model may refer to a type of learning model present in the network slices for which the subscription for the federated learning has been created. The type of learning model may be of string type and may be used for specifying the type of learning model present in the network slices. For instance, the learning model may be used for anomaly detection, the learning model may be used for quality of service (QoS) optimization. The end time for sending response to subscription of federated learning request may refer to a time when the subscription to the federated learning may end. The subscription start time may refer to a time when the subscription for the federated learning may be activated. The data type of subscription start time may be time and may specify the start time of the subscription. The subscription end time may refer to time when the subscription for the federated learning may expire. The data type of subscription end time may be time and may specify the end time of the subscription.

In an embodiment, the subscription request module 232 may create the subscription of the federated learning by evaluating the validity of the attributes associated with the subscription of the federated learning, upon receiving the request for creating the subscription of the federated learning. Then, the subscription of the federated learning may be created based on the attributes associated with the subscription of the federated learning.

Referring to FIG. 3, upon sending the indication with respect to the creation of the MOI for federated learning at operation 314, the network entity 106 may receive a request at operation 316 for creating an MOI for subscription of federated learning from the NSMF units 102. Then, the network entity 106 may create the MOI for subscription of federated learning at operation 318 based on the attributes associated with the subscription of the federated learning.

Referring to FIG. 2, upon creation of the subscription for the federated learning, the subscription response module 234 may send the response indicating the creation of the subscription for the federated learning, when the event with respect to the associated performance metric is identified. Referring to FIG. 3, upon creation of the MOI for subscription of federated learning at operation 318, the network entity 106 may send a response 320 indicating the creation of the subscription for the federated learning.

Referring to FIG. 2, upon sending the response indicating the creation of the subscription for the federated learning, to the respective NSMF units 102, the subscription request module 232 may send the updated learning model associated with the respective network slices 104 whenever modified data is received from the respective network slices 104. The learning model associated with the respective networks slice is updated with the modified data. (The modified data may be referred to as data hereafter). In an embodiment, the subscription request module 232 may receive the data associated with the respective network slices 104 periodically to update the learning model corresponding to the respective network slices 104. In another embodiment, the subscription request module 232 may receive the data whenever the network slices send the data. The subscription request module 232 may evaluate the received data against the attributes associated with the subscription of the federated learning. Then, the subscription request module 232 may update the learning model based on the data received from the respective network slices 104, upon evaluation of the received data. The subscription response module 234 may send the updated learning model associated with the respective network slices 104 to the respective NSMF units 102.

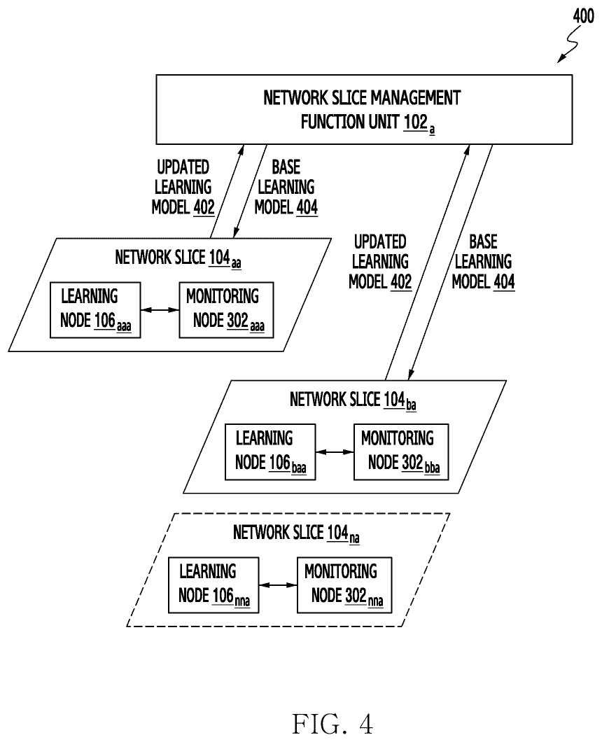

FIG. 4 shows illustrations for facilitating federated learning in a decentralized network slicing environment, according to an embodiment of the disclosure.

Referring to FIG. 4, each of network slices 104 may train the learning model (not shown explicitly in FIG. 4) present in the respective network slices 104 based on the data received from the respective network slices 104. Then, the network slices 104 may send the updated learning model to the network entity 106 associated with the respective network slices 104. The network entity 106 may aggregate the updated learning model. Further, the network entity 106 may evaluate the updated learning model against the attributes associated with the subscription of the federated learning. For instance, the updated learning model may be evaluated against the frequency of updates associated with the subscription and the subscription threshold value. Upon satisfying the updated learning model against the attributes associated with the subscription of the federated learning, the network entity 106 may send an updated learning model associated with the respective network slices 104 at operation 402, to the respective NSMF unit 102ₐ. For instance, a monitoring node 302ₐₐₐ may monitor events corresponding to an application in a network slice 104ₐₐ and provide data related to the monitored event to a learning model associated with the network slice 104ₐₐ for updating the monitored event in the learning model. Then, upon updating the learning model, the network slice 104ₐₐ may send the updated learning model to the network entity 106ₐₐₐ. Then, the network entity 106ₐₐₐ may send the updated learning model at operation 402 to the respective NSMF unit 102a.

Similarly, the NSMF units 102 may collect the updated learning models from each of the one or more network slices 104 associated with the NSMF units 102. For instance, the NSMF units 102ₐ may use monitoring tools such as network monitoring software to track request rates and detect anomalies and agents to collect the learning model. Then, the NSMF units 102 aggregate each of the updated leaning model received at operation 402 from the respective network slices 104, to create the final learning model in the decentralized network slicing environment. Each of the NSMF units 120 may be connected with each other via the block chain. Thus, facilitating improved and efficient federated learning for managing the network slices present in the decentralized environment. Further, the final learning model may be used to improve overall network performance, resource allocation, security, and other targeted use cases.

In an embodiment, the learning model present in each of the one or more network slices 104 may be a base learning model sent from the respective NSMF units 102 (as shown in operation 404 of FIG. 4) for learning the data locally present in the respective network slices 104.

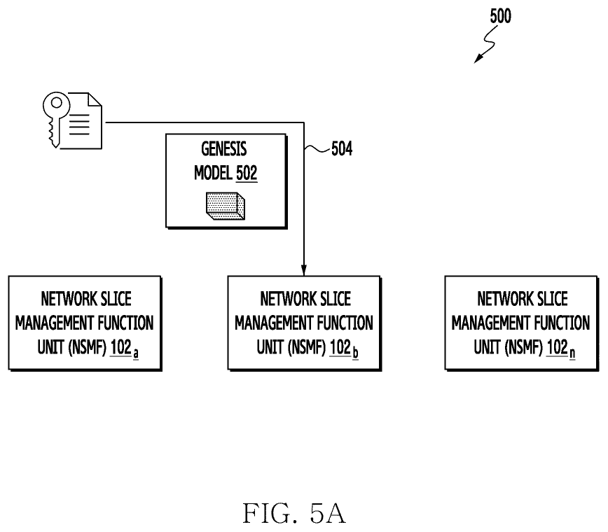

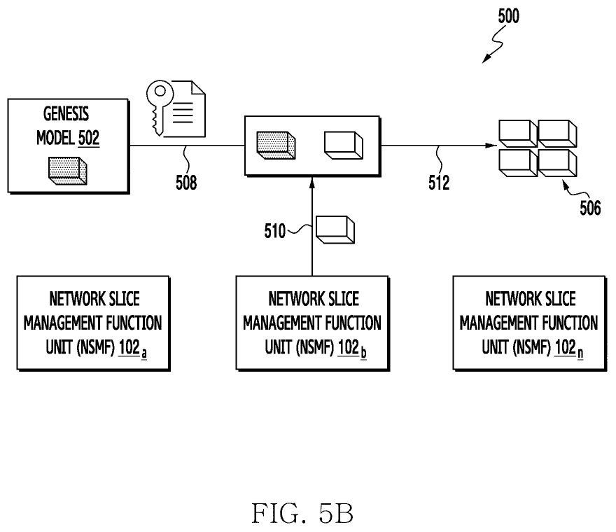

FIGS. 5A and 5B show illustrations for creation of a base learning model for facilitating federated learning in a decentralized network slicing environment, according to various embodiments of the disclosure.

The creation of a base learning model 506 is shown in FIG. 5B. In an embodiment, referring to FIG. 5A, among the NSMF units 102, one of the NSMF units may be selected as a leading NSMF unit 102b based on predefined rule for adding the base learning model. A genesis model 502 may be received at operation 504 by the leading NSMF unit 102b. Referring FIG. 5B, upon receiving the genesis model 502 at operation 508, a learning from the leading NSMF unit 102b is received at operation 510. The combination of the genesis model 502 and the learning from the leading NSMF unit 102b at operation 512 may form the base learning model 506.

Referring to FIG. 4, the base learning model received in operation 404 may be received by the associated network slices 104 from the respective NSMF units 102 for learning the data present in the respective network slices 104. Upon the base learning model learning the data from the respective network slices 104, the respective network slices 104 may send the learning in the form of updated learning model to the respective NSMF units 102. Then, the NSMF units 102 may aggregate the learning models received from one or more network slices 104 to form an aggregated learning model (not shown in FIG. 4). Then, the aggregated learning models received from different NSMF units 102, may be further aggregated at the NSMF units 102 level to form the final learning model.

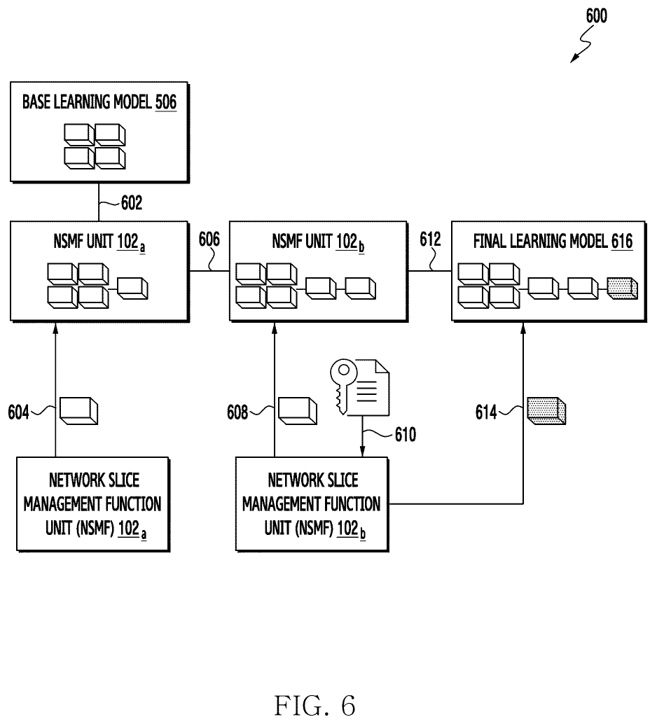

FIG. 6 shows illustrations for creation of a final learning model for facilitating federated learning in a decentralized network slicing environment, according to an embodiment of the disclosure.

In an embodiment, the final learning model 616 may be created by aggregating the learning received from each of the network slices 104 associated with the respective NSMF units 102. Initially, the base learning model 506 may be received at operation 602, then aggregated updated learning model may be received from each of the NSMF unit 102ₐ and a NSMF unit 102 at operations 604, 608, respectively. The smart contract may select the NSMF unit 102b as a leader to create the final learning model 616 at operation 610. Then, the aggregated updated learning models received from each of the respective NSMF units 102 may be aggregated with the base learning model 506 at operations 606 and 612 to form a final learning model 616, upon receive a trigger at operation 614 from a leading NSMF unit 102b. Each of the NSMF units 102 may be connected using the block chain.

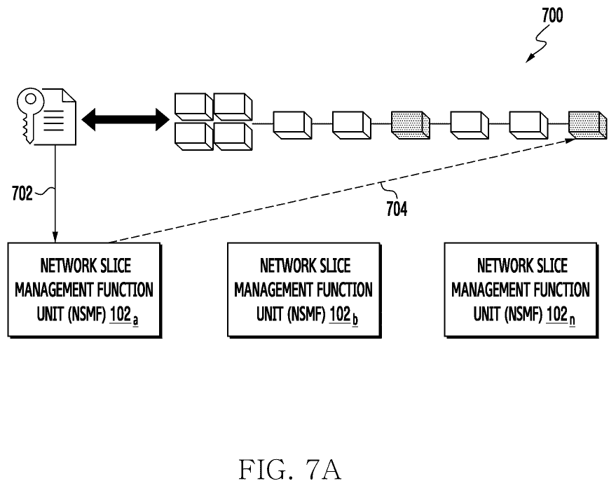

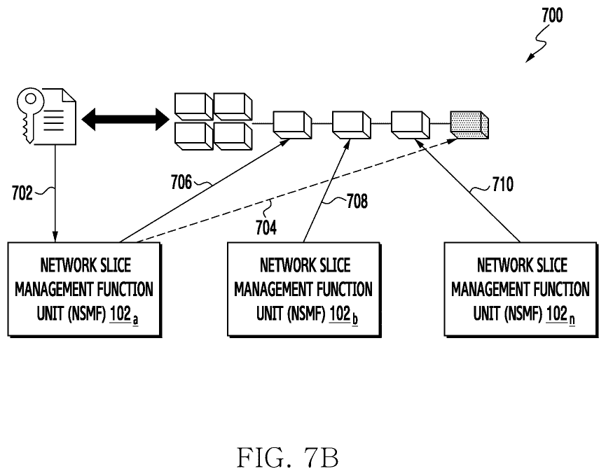

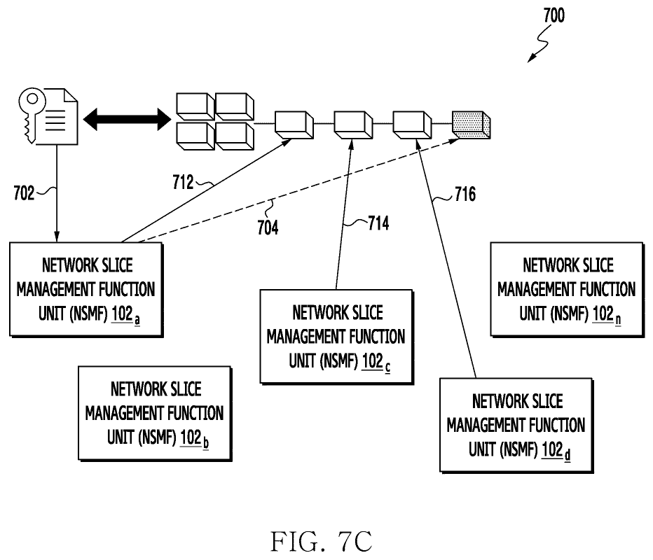

FIGS. 7A, 7B, and 7C show illustrations for creating the final learning model at different frequency, for facilitating federated learning in a decentralized network slicing environment, according to various embodiments of the disclosure.

FIG. 7A shows time based triggering for creating the final learning model. In an embodiment, the time based triggering may create the final learning model after a regular interval of time. For example, policies within the smart contract may be defined to create the final learning model after a time interval at operation 702. The NSMF unit 102a may trigger creating the final learning model at operation 704. In another embodiment, the time based triggering may create the final learning model at a predefined interval of time.

FIG. 7B shows creating the final learning model upon each of the one or more NSMF completing the learning from the associated one or more network slices 104. For instance, three NSMF units 102a, 102b and 102n may be present. For example, policies within the smart contract may be defined to create the final learning model after completion of the learning from the NSMF unit 102a, NSMF unit 102b, and NSMF unit 102n at operation 711. The NSMF unit 102a may add a learning at operation 712. The NSMF unit 102b may add a learning at operation 713. The NSMF unit 102n may add a learning at operation 714. Upon completion of the learning from the NSMF unit 102a, NSMF unit 102b and NSMF unit 102n, the NSMF unit 102a may trigger creating the final learning model at operation 715.

FIG. 7C shows creating the final learning model when the minimum number of updated learning models are received from each of the one or more NSMF units 102. The minimum number may be decided based on the leading NSMF unit 102ₐ. For example, policies within the smart contract may be defined to create the final learning model after the quorum is achieved at operation 721. The NSMF unit 102a may add a learning at operation 722. The NSMF unit 102c may add a learning at operation 723. The NSMF unit 102d may add a learning at operation 724. In the example depicted in FIG. 7C, the quorum (i.e., the minimum number of updated learning models) may be 3. Upon achieving the quorum, the NSMF unit 102a may trigger creating the final learning model at operation 725.

The disclosure may be implemented in various used cases including, but not limited to, achieving security in the network slices, accuracy in the network slices, latency in the network slices, resource utilization in the network slices, energy consumption in the network slices.

In an embodiment, the MOI may be created with respect to security of the application associated with the respective network slices 104. For creating MOI for security, the event may be detected as the security event for the application, by the network entity 106. Further, the object corresponding to the security event may be identified by the respective network entity 106. The object may be associated with the application. The security event may be classified as the attack by the network entity 106, based on predefined categories of attacks and the object corresponding to the security event, by comparing a value associated with the security event with a predefined threshold associated with the security event. For example, the predefined category of attacks may include, but not limited to, denial of service attack, phishing attack, and the like. Then, the learnings corresponding to the classification of the security event may be transmitted by the network entity 106 to the respective NSMF units 102 for creating the final learning model.

For instance, considering the security use case in the network slices 104. The attributes associated with security the use case may be:
a. Threshold: Greater than 10,000 requests per minute.
b. Event: Retrieve a single video file.
c. Object: VideoFile-A.
d. Classification: Denial of Service attack (DoS).

In the instance, upon creation of the MOI for a security federated learning for the network slices 104 and creating subscription to the security federated learning, the learning model present in the network slices 104 may detect that a more than 10,000 request received per minute to retrieve a VideoFile-A. Thus, the learning model may classify the event associated with the security federated learning as the Denial of Service attack (DoS). Then, the network slices 104 may send the learning model to the network entity 106. The network entity 106 may send the learning module to the respective NSMF unit 102. Similarly, the NSMF units may receive the learning module for all the associated network slices and aggregate the learning from the learning model to form the final learning model.

For instance, considering the accuracy use case in the network slices 104. The attributes associated with the accuracy use case may be:
a. Threshold: Greater than 90%
b. Event: Classify Slice KPI
c. Object: KPI dataset
d. Classification: High accuracy

In the instance, upon creation of the MOI for a performance federated learning for the network slices 104 and creating subscription to the performance federated learning, the learning model present in the network slices 104 may detect that more than 90% of slice KPI data are classified. Thus, the learning model may classify the event associated with the performance federated learning as the high performance, based on the detection. Then, the network slices 104 may send the learning model to the network entity 106. The network entity 106 may send the learning module to the respective NSMF unit 102. Similarly, the NSMF units may receive the learning module for all the associated network slices and aggregate the learning from the learning model to form the final learning model.

For instance, considering the latency use case in the network slices 104. The attributes associated with the latency use case may be:
a. Threshold: Less than 200 milliseconds
b. Event: Respond to user request
c. Object: Query response system
d. Classification: Low latency

In the instance, upon creation of the MOI for a latency federated learning for the network slices 104 and creating subscription to the latency federated learning, the learning model present in the network slices 104 may detect that less than 200 responses to request per millisecond. Thus, the learning model may classify the event associated with the latency federated learning as the low latency. The network entity 106 may send the learning module to the respective NSMF unit 102. Similarly, the NSMF units may receive the learning module for all the associated network slices and aggregate the learning from the learning model to form the final learning model.

For instance, considering the resource utilization use case in the network slices 104. The attributes associated with the resource utilization use case may be:
a. Threshold: Less than 80% CPU usage
b. Event: Slice management and Model training
c. Object: Server
d. Classification: Efficient resource use

In the instance, upon creation of the MOI for a resource utilization federated learning for the network slices 104 and creating subscription to the resource utilization federated learning, the learning model present in the network slices 104 may detect that more than 80% CPU usage on a server. Thus, the learning model may classify the event associated with the resource utilization federated learning as the efficient resource use. Then, the network slices 104 may send the learning model to the network entity 106. The network entity 106 may send the learning module to the respective NSMF unit 102. Similarly, the NSMF units may receive the learning module for all the associated network slices and aggregate the learning from the learning model to form the final learning model.

In an embodiment, the MOI may be created with respect to power usage of an application associated with the respective network slice 104. The event may be detected as the power event for the application, by the network entity 106. The object corresponding to the power event may be identified by the network entity 106. The object is associated with the application. The power event may be classified as the training cycle by the network entity 106, based on predefined categories of training cycle and the object corresponding to the power event, by comparing a value the power event with a predefined threshold associated with the power event. For example, the predefined category of training cycle may include but not limited to training cluster. Then, the learnings corresponding to the classification of the power event may be transmitted by the network entity 106 to the respective NSMF units 102 for creating the final learning model.

For instance, considering the energy consumption use case in the network slices 104. The attributes associated with the energy consumption use case may be:
a. Threshold: Less than 100 kWh
b. Event: Complete training cycle
c. Object: Training cluster
d. Classification: Energy efficient

In the instance, upon creation of the MOI for the power usage federated learning for the network slices 104 and creating subscription to the power usage federated learning, the learning model present in the network slices 104 may detect that less than 100 kilowatt complete training cycle per hour. Thus, the learning model may classify the event associated with the power usage federated learning as energy efficient. Then, the network slices 104 may send the learning model to the network entity 106. The network entity 106 may send the learning module to the respective NSMF unit 102. Similarly, the NSMF units may receive the learning module for all the associated network slices and aggregate the learning from the learning model to form the final learning model.

Thus, the disclosure may be implemented in various scenarios to ensure robust, efficient, and secure model by incorporating the attributes associated with each of the use cases.

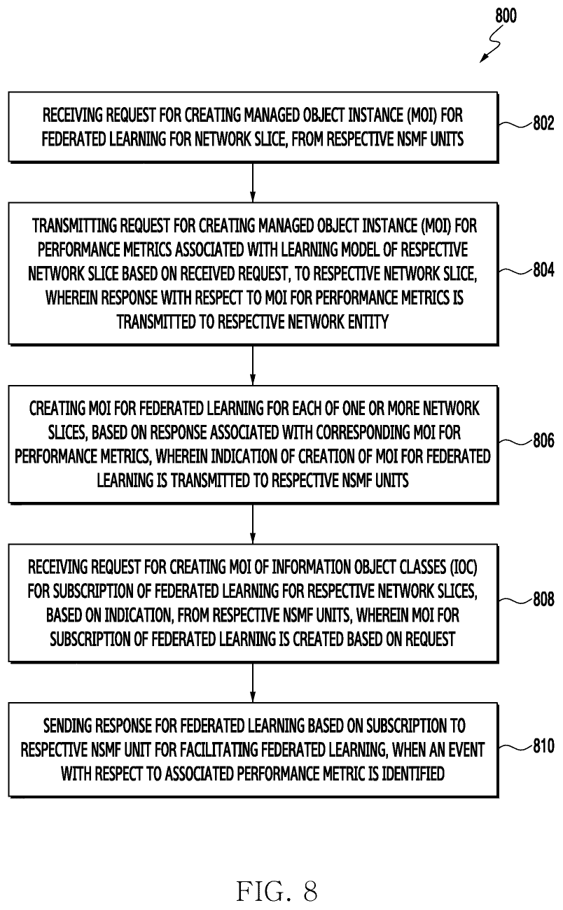

FIG. 8 shows a flowchart illustrating method operations for facilitating federated learning in the decentralized network slicing environment according to an embodiment of the disclosure.

Referring to FIG. 8, a method 800 for facilitating federated learning in the decentralized network slicing environment may include one or more operations. The method 800 may be described in the general context of computer executable instructions. Generally, computer executable instructions can include routines, programs, objects, components, data structures, procedures, modules, and functions, which perform particular functions or implement particular abstract data types.

The order in which the method 800 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 802, the request for creating the MOI for federated learning for the network slice 104 may be received by the network entity 106, from the respective NSMF units 102.

At operation 804, the request for creating the MOI for performance metrics associated with the learning model of the respective network slice 104 may be transmitted by the network entity 106, based on the received request, to the respective network slice 104. The response with respect to the MOI for performance metrics may be transmitted to the respective network entity 106. The performance metrics may include MOI attributes, but not limited to, threshold, type of event, one or more objects associated with the event and classification of the event.

At operation 806, the MOI for the federated learning for each of the one or more network slices 104 may be created by the network entity 106, based on the response associated with the corresponding MOI for performance metrics. The indication of the creation of the MOI for the federated learning may be transmitted to the respective NSMF units 102.

At operation 808, the request for creating the MOI of the IOC for the subscription of the federated learning for the respective network slices 104 may be received from the network entity 106, based on the indication, from the respective NSMF units 102. The MOI for subscription of the federated learning is created based on the request. The subscription of the federated learning may include subscription attributes such as, but not limited to a subscription ID, subscriber ID, type of federated learning, the frequency of updates associated with the subscription, a subscription threshold value, type of the learning model, an end time for sending response to subscription of federated learning request, subscription start time and subscription end time.

At operation 810, the response for the federated learning may be sent by the network entity 106, based on the subscription to the respective NSMF unit 102 for facilitating federated learning, when the event with respect to the associated performance metric may be identified.

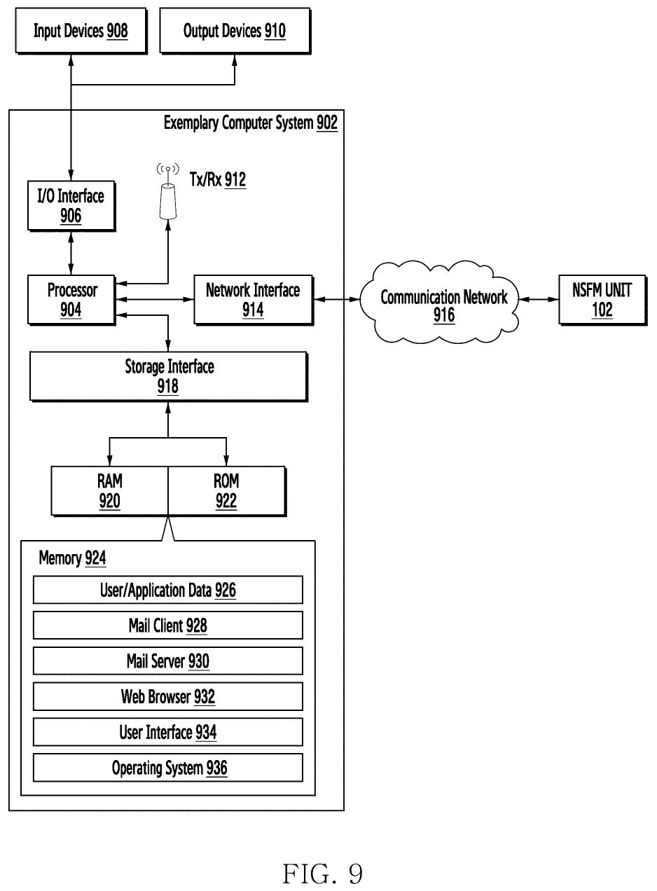

FIG. 9 illustrates a block diagram of a computer system for facilitating federated learning in a decentralized network slicing environment according to an embodiment of the disclosure.

Referring to FIG. 9, a computer system 902 may include the network entity and the monitoring node. Thus, the computer system 902 may be used for facilitating federated learning in a decentralized network slicing environment. The computer system 902 and the NSMF unit 102 may be connected via an interface. The interface may include an internal interface or an external interface. The computer system 902 may include a Central Processing Unit 904 (also referred as “CPU”, “processor 904” or a controller). The processor 904 may include at least one data processor. The processor 904 may include specialized processing units such as integrated system (bus) controllers, memory management control units, floating point units, graphics processing units, digital signal processing units, etc.

The processor 904 may be configured to communicate with one or more input/output (I/O) devices via I/O interface 906. The I/O interface 906 may employ communication protocols/methods such as, without limitation, audio, analog, digital, monoaural, RCA, stereo, Institute of Electrical and Electronics Engineers (IEEE)-1394, serial bus, universal serial bus (USB), infrared, PS/2, Bayonet Neill-Concelman (BNC), coaxial, component, composite, digital visual interface (DVI), high-definition multimedia interface (HDMI), Radio Frequency (RF) antennas, super video (S-Video), video graphics array (VGA), IEEE 802.n/b/g/n/x, Bluetooth™, cellular (e.g., code-division multiple access (CDMA), high-speed packet access (HSPA+), global system for mobile communications (GSM), long-term evolution (LTE), worldwide interoperability for microwave access (WiMax), or the like), etc. In an embodiment, the transceiver 912 may be disposed in connection with the processor 904. The transceiver 912 may facilitate various types of wireless transmission or reception. For example, the transceiver 912 may include an antenna operatively connected to transceiver circuitry.

Using the I/O interface 906, the computer system 902 may communicate with one or more I/O devices. For example, input devices 908 may include an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 910 may include a printer, fax machine, video display (e.g., cathode ray tube (CRT), liquid crystal display (LCD), light-emitting diode (LED), plasma, Plasma display panel (PDP), organic light-emitting diode display (OLED) or the like), audio speaker, etc.

The processor 904 may be configured to communicate with a communication network 916 via a network interface 914. The network interface 914 may communicate with the communication network 916. The computer system 902 may communicate with the NSMF units 102 via the communication network 916. The network interface 914 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 916 may include, without limitation, a direct interconnection, local area network (LAN), wide area network (WAN), wireless network (e.g., using Wireless Application Protocol), the Internet, etc. The network interface 914 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 916 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi™, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In an example embodiment, the processor 904 may be configured to communicate with memory 924 (e.g., random access memory (RAM) 920, read only memory (ROM) 922, etc.) via a storage interface 918. The storage interface 918 may connect to memory 924 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 924 may store a collection of program or database components, including, without limitation, user/application data 926, mail client 928, mail server 930, user interface 934, an operating system 936, web browser 932 etc. In an example embodiment, computer system 902 may store user/application data, such as, the data, variables, records, etc., as described in this disclosure. Such databases may be implemented as fault-tolerant, relational, scalable, secure databases such as Oracle® or Sybase®.

The operating system 936 may facilitate resource management and operation of the computer system 902. Examples of operating systems include, without limitation, APPLE MACINTOSH™ OS X, UNIX™, UNIX-like system distributions (E.G., BERKELEY SOFTWARE DISTRIBUTION™ (BSD), FREEBSD™ NETBSD™, OPENBSD™, etc.), LINUX DISTRIBUTIONS™ (E.G., RED HAT™ UBUNTU™, KUBUNTU™, etc.), IBM™ OS/2, MICROSOFT™ WINDOWS™ (XP™, VISTA™/7/8, 10 etc.), APPLE™ IOS™, GOOGLE™ ANDROID™ BLACKBERRY™ OS, or the like.

In an example embodiment, the computer system 902 may implement the web browser 932 stored program component. The web browser 932 may be a hypertext viewing application, for example MICROSOFT™ INTERNET EXPLORER™ GOOGLE™ CHROME™, MOZILLA™ FIREFOX™, APPLE™ SAFARIT, etc. Secure web browsing may be provided using Secure Hypertext Transport Protocol (HTTPS), Secure Sockets Layer (SSL), Transport Layer Security (TLS), etc. Web browsers 932 may utilize facilities such as AJAX™, DHTML™, ADOBE™ FLASH™, JAVASCRIPT™, JAVA™, Application Programming Interfaces (APIs), etc. In an example embodiment, the computer system 902 may implement a mail server stored program component. The mail server may be an Internet mail server such as Microsoft Exchange, or the like. The mail server may utilize facilities such as ASP™ ACTIVEX™, ANSI™ C++/C#, MICROSOFT™, .NET™, CGI SCRIPTS™, JAVA™ JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT™ exchange, Post Office Protocol (POP), Simple Mail Transfer Protocol (SMTP), or the like. In an example embodiment, the computer system 902 may implement a mail client stored program component. The mail client may be a mail viewing application, such as APPLE™ MAIL™, MICROSOFT™ ENTOURAGE™, MICROSOFT™ OUTLOOK™, MOZILLA™ THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform operations or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memories (CD ROMs), Digital Versatile Discs (DVDs), flash drives, disks, and any other known physical storage media.

According to an example embodiment, there is provided a method and a network entity for facilitating federated learning in the decentralized network slicing environment. In the disclosure, the network entity creates MOI for federated learning based on performance metrices. Then, the subscription of the federated learning may be created based on the MOI for federated learning. Hence, the federated learning may help in managing all the network slices present in the decentralized environment. Thus, leads to improved and efficient management of the network slices. Further, as the disclosure facilities aggregated learning from each of the one or more network slices to the NSMF units, handling data heterogeneity across different network slices associated with different NSMF units is achieved. The disclosure may eliminate problems in facilitating learning from a new network slice added with the decentralized network environment due to insufficient data, as the disclosure aggregates learning from diverse sources with varying data distributions associated with each of the one or more network slices to create the final learning model. Further, the final learning model may be implemented in the new network slice for monitoring events associated with the new network slice. Thus, the disclosure ensures secure learning model aggregation in decentralized network slicing environment for preventing adversarial nodes or malicious events from compromising integrity and accuracy of the aggregated learning models.

In the above example embodiments, components according to example embodiments of the disclosure are referenced by using modules or units. The modules or units may be implemented with various hardware devices, such as an integrated circuit, an application specific integrated circuit (ASIC), a field programmable gate array (FPGA), and a complex programmable logic device (CPLD), firmware driven in hardware devices, software such as an application, or a combination of a hardware device and software. Also, the modules or units may include circuits implemented with semiconductor elements in an integrated circuit, or circuits enrolled as an intellectual property (IP).

The terms “an example embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an example embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 8 show certain events occurring in a certain order. In alternative embodiments, certain operations may be performed in a different order, modified, or removed. Moreover, operations may be added to the above-described logic and still conform to the described embodiments. Further, operations described herein may occur sequentially or certain operations may be processed in parallel. Yet further, operations may be performed by a single processing unit or by distributed processing units.

According to embodiments, a method may be performed by a network entity for facilitating federated learning in a decentralized network slicing environment. The method may comprise receiving, by a network entity (106) present in each of one or more network slices associated with each of one or more Network Slice Management Function (NSMF) units (102), a request for creating a Managed Object Instance (MOI) for federated learning for the network slice, from the respective NSMF units (102). The method may comprise transmitting, by the network entity (106), a request for creating a Managed Object Instance (MOI) for performance metrics associated with a learning model of the respective network slice based on the received request, to the respective network slice, wherein a response with respect to the MOI for performance metrics is transmitted to the respective network entity (106). The method may comprise creating, by the network entity (106), the MOI for the federated learning for each of the one or more network slices (104), based on the response associated with the corresponding MOI for performance metrics, wherein an indication of the creation of the MOI for the federated learning is transmitted to the respective NSMF units (102). The method may comprise receiving, by the network entity (106), a request for creating an MOI of an Information Object Classes (IOC) for a subscription of the federated learning for the respective network slices (104), based on the indication, from the respective NSMF units (102), wherein the MOI for subscription of the federated learning is created based on the request. The method may comprise sending, by the network entity (106), a response for the federated learning based on the subscription to the respective NSMF unit (102) for facilitating federated learning, when an event with respect to the associated performance metric is identified.

In an embodiment, the performance metrics may comprise MOI attributes may comprise threshold, type of event, one or more objects associated with the event and classification of the event.

In an embodiment, creating the MOI for performance metrics may comprise identifying Key Performance Indicators (KPIs) corresponding to an application associated with respective network slices (104), determining a threshold for each of the KPIs, determining the event performed on the application and an object associated with the application, and classifying a result of the event based on the KPIs, the threshold, the event performed on the application and the object, to create the MOI for performance metrices corresponding to the application.

In an embodiment, the MOI for the subscription of the federated learning is created by evaluating, by the network entity (106), validity of attributes associated with the subscription of the federated learning, based on the request received for creating the subscription of the federated learning, and sending, by the network entity (106), the response for the federated learning based on the subscription to the respective NSMF units (102) along with a subscription ID, based on the evaluation.

In an embodiment, the method may comprise receiving, by the network entity (106), data associated with the respective network slice periodically, to update the learning model corresponding to the respective network slices (104), evaluating, by the network entity (106), the received data against attributes associated with the subscription of the federated learning, updating, by the network entity (106), the learning model based on the respective received data, and sending, by the network entity (106), the updated learning model associated with the respective network slices (104) to the respective NSMF units (102). The updated learning model associated with each of the respective network slices (104) may be aggregated to create a final learning model in a decentralized network slicing environment.

In an embodiment, creating the MOI with respect to security of an application associated with the respective network slice may comprise detecting, by the network entity (106), the event as a security event for the application, identifying, by the network entity (106), an object corresponding to the security event, wherein the object is associated with the application, classifying, by the network entity (106), the security event as an attack based on predefined categories of attacks and the object corresponding to the security event, by comparing a value associated with the security event with a predefined threshold associated with the security event, and transmitting, by the network entity (106), learnings corresponding to the classification of the security event, to the respective NSMF units (102).

In an embodiment, creating the MOI with respect to power usage of an application associated with the respective network slice may comprise detecting, by the network entity (106), the event as a power event for the application, identifying, by the network entity (106), an object corresponding to the power event, wherein the object is associated with the application, classifying, by the network entity (106), the power event as a training cycle based on predefined categories of training cycle and the object corresponding to the power event, by comparing a value the power event with a predefined threshold associated with the power event, and transmitting, by the network entity (106), learnings corresponding to the classification of the power event, to the respective NSMF units (102).

According to embodiments, a network entity (106) for facilitating federated learning in a decentralized network slicing environment, the network entity (106) may comprise a processor. The network entity (106) may comprise memory storing processor-executable instructions. The processor-executable instructions may cause the processor to receive a request for creating a Managed Object Instance (MOI) for federated learning for the network slice, from the respective NSMF units (102). The processor-executable instructions may cause the processor to transmit a request for creating a Managed Object Instance (MOI) for performance metrics associated with a learning model of the respective network slice based on the received request, to the respective network slice, wherein a response with respect to the MOI for performance metrics is transmitted to the respective network entity (106). The processor-executable instructions may cause the processor to create the MOI for the federated learning for each of the one or more network slices (104), based on the response associated with the corresponding MOI for performance metrics, wherein an indication of the creation of the MOI for the federated learning is transmitted to the respective NSMF units (102). The processor-executable instructions may cause the processor to receive a request for creating an MOI of an Information Object Classes (IOC) for a subscription of the federated learning for the respective network slices (104), based on the indication, from the respective NSMF units (102), wherein the MOI for subscription of the federated learning is created based on the request. The processor-executable instructions may cause the processor to send a response for the federated learning based on the subscription to the respective NSMF unit (102) for facilitating federated learning, when an event with respect to the associated performance metric is identified.

In an embodiment, the performance metrics may comprise MOI attributes may comprise threshold, type of event, one or more objects associated with the event and classification of the event.

In an embodiment, the processor may be configured to create the MOI for performance metrics by identifying Key Performance Indicators (KPIs) corresponding to an application associated with respective network slices (104), determining a threshold for each of the KPIs, determining the event performed on the application and an object associated with the application, and classifying a result of the event based on the KPIs, the threshold, the event performed on the application and the object, to create the MOI for performance metrices corresponding to the application.

In an embodiment, the subscription of the federated learning may comprise subscription attributes comprising: a subscription ID, subscriber ID, type of federated learning, frequency of subscription, a subscription threshold value, type of the learning model, an end time for sending response to subscription of federated learning request, predefined parameters associated with the subscription, subscription start time and subscription end time.

In an embodiment, the processor may be configured to create the MOI for the subscription of the federated learning by evaluating validity of attributes associated with the subscription of the federated learning, based on the request received for creating the subscription of the federated learning, and sending the response for the federated learning based on the subscription to the respective NSMF units (102) along with a subscription ID, based on the evaluation.

In an embodiment, the processor may be configured to receive data associated with the respective network slice periodically, to update the learning model corresponding to the respective network slices (104), evaluate the received data against attributes associated with the subscription of the federated learning, update the learning model based on the respective received data, and send the updated learning model associated with the respective network slices (104) to the respective NSMF units (102). The updated learning model associated with each of the respective network slices (104) may be aggregated to create a final learning model in a decentralized network slicing environment.

In an embodiment, the processor may create the MOI with respect to security of an application associated with the respective network slice by detecting the event as a security event for the application, identifying an object corresponding to the security event, wherein the object is associated with the application, classifying the security event as an attack based on predefined categories of attacks and the object corresponding to the security event, by comparing a value associated with the security event with a predefined threshold associated with the security event, and transmitting learnings corresponding to the classification of the security event, to the respective NSMF units (102).

In an embodiment, the processor may create the MOI with respect to power usage of an application associated with the respective network slice by detecting the event as a power event for the application, identifying an object corresponding to the power event, wherein the object is associated with the application, classifying the power event as a training cycle based on predefined categories of training cycle and the object corresponding to the power event, by comparing a value the power event with a predefined threshold associated with the power event, and transmitting learnings corresponding to the classification of the power event, to the respective NSMF units (102).

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network entity for facilitating federated learning in a decentralized network slicing environment, the method comprising:
receiving, by the network entity present in each of one or more network slices associated with each of one or more network slice management function (NSMF) units, a request for creating a managed object instance (MOI) for federated learning for a network slice, from respective NSMF units;
transmitting, by the network entity to a respective network slice, a request for creating an MOI for performance metrics associated with a learning model of the respective network slice based on the received request, wherein a response with respect to the MOI for performance metrics is transmitted to a respective network entity;
creating, by the network entity, the MOI for the federated learning for each of the one or more network slices, based on the response associated with a corresponding MOI for performance metrics, wherein an indication of the creating of the MOI for the federated learning is transmitted to the respective NSMF units;
receiving, by the network entity from the respective NSMF units, a request for creating an MOI of an information object classes (IOC) for a subscription of the federated learning for respective network slices, based on the indication, wherein the MOI for subscription of the federated learning is created based on the request; and
sending, by the network entity to a respective NSMF unit, a response for the federated learning based on the subscription for facilitating federated learning, when an event with respect to an associated performance metric is identified.

2. The method of claim 1, wherein the performance metrics comprises MOI attributes including threshold, type of event, one or more objects associated with the event, and classification of the event.

3. The method of claim 1, wherein creating the MOI for performance metrics comprises:
identifying key performance indicators (KPIs) corresponding to an application associated with respective network slices;
determining a threshold for each of the KPIs;
determining the event performed on the application and an object associated with the application; and
classifying a result of the event based on the KPIs, the threshold, the event performed on the application and the object, to create the MOI for performance metrices corresponding to the application.

4. The method of claim 1, wherein the subscription of the federated learning comprises subscription attributes including a subscription identifier (ID), subscriber ID, type of federated learning, frequency of subscription, a subscription threshold value, type of the learning model, an end time for sending response to subscription of federated learning request, subscription start time, and subscription end time.

5. The method of claim 1, wherein the MOI for the subscription of the federated learning is created by:
evaluating, by the network entity, validity of attributes associated with the subscription of the federated learning, based on the request received for creating the subscription of the federated learning; and
sending, by the network entity, the response for the federated learning based on the subscription to the respective NSMF units along with a subscription identifier (ID), based on the evaluating.

6. The method of claim 1, further comprising:
receiving, by the network entity, data associated with the respective network slice periodically, to update the learning model corresponding to the respective network slices;
evaluating, by the network entity, the received data against attributes associated with the subscription of the federated learning;
updating, by the network entity, the learning model based on the received data; and
sending, by the network entity, the updated learning model associated with the respective network slices to the respective NSMF units,
wherein the updated learning model associated with each of the respective network slices are aggregated to create a final learning model in a decentralized network slicing environment.

7. The method of claim 1, wherein creating the MOI with respect to security of an application associated with the respective network slice comprises:
detecting, by the network entity, the event as a security event for the application;
identifying, by the network entity, an object corresponding to the security event, wherein the object is associated with the application;
classifying, by the network entity, the security event as an attack based on predefined categories of attacks and the object corresponding to the security event, by comparing a value associated with the security event with a predefined threshold associated with the security event; and
transmitting, by the network entity to the respective NSMF units, learnings corresponding to the classifying of the security event.

8. The method of claim 1, wherein creating the MOI with respect to power usage of an application associated with the respective network slice comprises:
detecting, by the network entity, the event as a power event for the application;
identifying, by the network entity, an object corresponding to the power event, wherein the object is associated with the application;
classifying, by the network entity, the power event as a training cycle based on predefined categories of training cycle and the object corresponding to the power event, by comparing a value of the power event with a predefined threshold associated with the power event; and
transmitting, by the network entity, learnings corresponding to the classifying of the power event, to the respective NSMF units.

9. A network entity for facilitating federated learning in a decentralized network slicing environment, the network entity comprises:
memory, comprising one or more storage media, storing instructions; and
one or more processors communicatively coupled to the memory, wherein the instructions, when executed by the one or more processors individually or collectively, cause the network entity to:
receive a request for creating a managed object instance (MOI) for federated learning for a network slice, from respective network slice management function (NSMF) units,
transmit, to a respective network slice, a request for creating an MOI for performance metrics associated with a learning model of the respective network slice based on the received request, wherein a response with respect to the MOI for performance metrics is transmitted to a respective network entity,
create the MOI for the federated learning for each of one or more network slices, based on the response associated with a corresponding MOI for performance metrics, wherein an indication of the creating of the MOI for the federated learning is transmitted to the respective NSMF units,
receive, from the respective NSMF units, a request for creating an MOI of an information object classes (IOC) for a subscription of the federated learning for respective network slices, based on the indication, wherein the MOI for subscription of the federated learning is created based on the request, and
send, to a respective NSMF unit, a response for the federated learning based on the subscription for facilitating federated learning, when an event with respect to an associated performance metric is identified.

10. The network entity of claim 9, wherein the performance metrics comprises MOI attributes including threshold, type of event, one or more objects associated with the event, and classification of the event.

11. The network entity of claim 9, wherein, to create the MOI for performance metrics, the instructions, when executed by the one or more processors individually or collectively, further cause the network entity to:
identify key performance indicators (KPIs) corresponding to an application associated with respective network slices;
determine a threshold for each of the KPIs;
determine the event performed on the application and an object associated with the application; and
classify a result of the event based on the KPIs, the threshold, the event performed on the application and the object, to create the MOI for performance metrices corresponding to the application.

12. The network entity of in claim 9, wherein the subscription of the federated learning comprises subscription attributes including a subscription identifier (ID), subscriber ID, type of federated learning, frequency of subscription, a subscription threshold value, type of the learning model, an end time for sending response to subscription of federated learning request, predefined parameters associated with the subscription, subscription start time, and subscription end time.

13. The network entity of claim 9, wherein, to create the MOI for the subscription of the federated learning, the instructions, when executed by the one or more processors individually or collectively, further cause the network entity to:
evaluate validity of attributes associated with the subscription of the federated learning, based on the request received for creating the subscription of the federated learning; and
send the response for the federated learning based on the subscription to the respective NSMF units along with a subscription identifier (ID), based on the evaluating.

14. The network entity of claim 9,
wherein the instructions, when executed by the one or more processors individually or collectively, further cause the network entity to:
receive data associated with the respective network slice periodically, to update the learning model corresponding to the respective network slices;
evaluate the received data against attributes associated with the subscription of the federated learning;
update the learning model based on the received data; and
send the updated learning model associated with the respective network slices to the respective NSMF units, and
wherein the updated learning model associated with each of the respective network slices are aggregated to create a final learning model in a decentralized network slicing environment.

15. The network entity of claim 9, wherein, to create the MOI with respect to security of an application associated with the respective network slice, the instructions, when executed by the one or more processors individually or collectively, further cause the network entity to:
detect the event as a security event for the application;
identify an object corresponding to the security event, wherein the object is associated with the application;
classify the security event as an attack based on predefined categories of attacks and the object corresponding to the security event, by comparing a value associated with the security event with a predefined threshold associated with the security event; and
transmit, to the respective NSMF units, learnings corresponding to the classifying of the security event.

16. The network entity of claim 9, wherein, to create the MOI with respect to power usage of an application associated with the respective network slice, the instructions, when executed by the one or more processors individually or collectively, further cause the network entity to:
detect the event as a power event for the application;
identify an object corresponding to the power event, wherein the object is associated with the application;
classify the power event as a training cycle based on predefined categories of training cycle and the object corresponding to the power event, by comparing a value of the power event with a predefined threshold associated with the power event; and
transmit, to the respective NSMF units, learnings corresponding to the classifying of the power event.

17. The network entity of claim 9, wherein each of the respective NSMF units are connected with each other via a block chain.

18. The network entity of claim 12, wherein the subscriber ID includes a string type used for identifying an entity subscribing to an application associated with the respective network slices.

19. One or more non-transitory computer-readable storage media storing one or more computer programs including computer-executable instructions that, when executed by one or more processors of a network entity individually or collectively, cause the network entity to perform operations, the operations comprising:
receiving, by the network entity present in each of one or more network slices associated with each of one or more network slice management function (NSMF) units, a request for creating a managed object instance (MOI) for federated learning for a network slice, from respective NSMF units;
transmitting, by the network entity to a respective network slice, a request for creating an MOI for performance metrics associated with a learning model of the respective network slice based on the received request, wherein a response with respect to the MOI for performance metrics is transmitted to a respective network entity;
creating, by the network entity, the MOI for the federated learning for each of the one or more network slices, based on the response associated with a corresponding MOI for performance metrics, wherein an indication of the creating of the MOI for the federated learning is transmitted to the respective NSMF units;
receiving, by the network entity from the respective NSMF units, a request for creating an MOI of an information object classes (IOC) for a subscription of the federated learning for respective network slices, based on the indication, wherein the MOI for subscription of the federated learning is created based on the request; and
sending, by the network entity to a respective NSMF unit, a response for the federated learning based on the subscription for facilitating federated learning, when an event with respect to an associated performance metric is identified.

20. The one or more non-transitory computer-readable storage media of claim 19, wherein the performance metrics comprises MOI attributes including threshold, type of event, one or more objects associated with the event, and classification of the event.
